(19) United States
(12) Patent Application Publication
(10) Pub. No.: US 2010/0311455 A1
(43) Pub. Date: Dec. 9, 2010

(54) Distributed Arbitration

(75) Inventors: Dean Armstrong, Cambridge (GB); Alexander Thoukydides, Cambridge (GB)

Correspondence Address: Novak Druce DeLuca + Quigg LLP (CSR), 300 New Jersey Avenue, NW, Fifth Floor, Washington, DC, 20001, US

(73) Assignee: CAMBRIDGE SILICON RADIO LIMITED, Cambridge, GB (GB)

(21) Appl. No.: 12/747,933

(22) PCT Filed: Nov. 19, 2008
(86) PCT No.: PCT/EP08/65811

§ 371 Date: Jul. 16, 2010

(30) Foreign Application Priority Data
Dec. 14, 2007 (GB) 0724434.6

(51) Int. Cl. H04B 7/00

(52) U.S. Cl. 455/512

(57) ABSTRACT

A communication unit for communicating data in dependence on a priority associated with a data communication to be made by that communication unit and on a priority associated with a data communication to be made by another communication unit, the communication unit being arranged to assign a priority to a data communication to be made by the communication unit, make an adjustment to the priority to form an adjusted priority, the adjustment being independent of an adjustment made by the other communication unit to a priority assigned to a data communication to be made by that communication unit and communicate the adjusted priority to the other communication unit as being the priority associated with the data communication to be made by the communication unit.

The invention relates to a distributed arbitration scheme and a radio for implementing distributed arbitration.

Communication devices that communicate using the ISM radio bands (industrial, scientific and medical radio bands) should be able to tolerate interfering transmissions within those radio bands. This interference increases the closer together two radios operating within the same ISM radio band are located.

Communication protocols that use the ISM radio bands include Bluetooth™, HIPERLAN and the IEEE 802.11 protocols for wireless networks. Some communication devices have the ability to communicate using more than one of these protocols. For example, laptops are commonly able to communicate via Bluetooth and over a wireless LAN. Such devices will typically contain a radio for each protocol. Because these radios are located within the same device, they are necessarily located close enough together for interference to be a problem. This is particularly the case when one of the radios is receiving while the other radio is transmitting. The transmitting signal can tend to interfere with the received signal to such an extent that the signal cannot be correctly decoded. Therefore, a way of scheduling communication operations in collocated radios is required to minimise the number of communications that are subject to a problematic level of interference.

One way for scheduling communications between different radios in a communication device is to have a central arbiter for scheduling transmissions. Typically, each collocated radio communicates relevant activity parameters to the central arbiter so that the central arbiter can schedule communication activity between the radios. The activity parameters may include type of activity (transmit or receive), frequency of operation, timing and a priority level associated with the activity. The central arbiter may then use the activity parameters to identify proposed communications that are likely to interfere. Often the arbiter uses some kind of arbitration logic to enforce a time-division multiple-access scheduling procedure to the shared medium. Where the activity parameters indicate that data loss due to interference is likely if the radios communicate as proposed, the arbiter commonly uses the priority values provided by the radios to distinguish between activities.

The arbiter may distinguish between priority levels on a deterministic basis, so that the proposed activity having the highest priority level is always the activity that is permitted to proceed. However, a deterministic approach is not always appropriate. Where proposed activities are associated with the same priority level a stalemate situation may occur because neither activity can be selected above the other. Also, it is likely that proposed communication activities having relatively low priority levels will rarely, if ever, be scheduled because of the likelihood of there frequently being an interfering activity having a higher priority level. Instead, a form of non-deterministic arbitration may be preferable, especially when priorities are similar, in order to provide a fair distribution of service to the radios involved.

One way of implementing a non-deterministic arbitration scheme is for the central arbiter to compare a randomly selected number against a threshold based on the appropriate priority level represented as a number.

An alternative to using a central arbiter is to use a distributed arbitration scheme in which the individual radios convey their activity parameters to the other potentially interfering radios within the device. A distributed arbitration scheme provides significant benefits over a central arbitration scheme, particularly in terms of implementation scalability. Each radio may then determine whether its proposed communication activity is likely to interfere with the proposed activity of another radio in the device. The radio then independently decides whether or not to proceed with its activity. Each radio should preferably use the same arbitration logic when deciding whether or not to proceed so that scheduling of transmissions is consistent throughout the device and so that the available communication resources are used efficiently. Consistent arbitration decisions are especially important when the radios require the exclusive right to operate, e.g. when one antenna is switched between the radios.

It is preferable when using a distributed arbitration scheme to use a form of non-deterministic arbitration, for largely the same reasons as when a central arbitration scheme is being used. However, the non-deterministic scheme implemented by central arbiters is not suitable for multiply distributed arbiters because having distributed arbiters each comparing an independently selected random number against a threshold would tend to lead to inconsistent decisions and potentially inefficient use of the medium.

Therefore, there is a need for a way of implementing non-deterministic decisions in a consistent fashion in a distributed arbitration system.

According to a first embodiment of the invention, there is provided a communication unit for communicating data in dependence on a priority associated with a data communication to be made by that communication unit and on a priority associated with a data communication to be made by another communication unit, the communication unit being arranged to assign a priority to a data communication to be made by the communication unit, make an adjustment to the priority to form an adjusted priority, the adjustment being independent of an adjustment made by the other communication unit to a priority assigned to a data communication to be made by that communication unit and communicate the adjusted priority to the other communication unit as being the priority associated with the data communication to be made by the communication unit.

The communication unit may be arranged to determine whether and/or when to communicate its data in dependence on the adjusted priority.

The communication unit may be arranged to receive a priority associated with a data communication to be made by the other communication unit from the other unit.

The communication unit may be arranged to communicate its data in dependence on the priority received from the other unit.

The communication unit may be arranged to receive from the other communication unit data defining communication resources that the other unit requires to make a data communication, the communication unit being arranged to determine from that data if the data communication to be made by the communication unit and the data communication to be made by the other unit would interfere.

The communication unit may be arranged to, if it determines that the data communication to be made by the communication unit and the data communication to be made by the other unit would interfere, communicate its data in dependence on the adjusted priority and the priority associated with the data communication to be made by the other unit.

The communication unit may be arranged to, if the adjusted priority is higher than the priority associated with the data communication to be made by the other unit, communicate its data.

The communication unit may be arranged to, if the adjusted priority is lower than the priority associated with the data communication to be made by the other unit, not communicate its data.

The communication unit may be arranged to receive an adjusted priority associated with a data communication to be made by the other communication unit from the other unit and to treat the adjusted priority as being the priority associated with that data communication.

The communication unit may be arranged to assign a number as being the priority associated with a data communication to be made by the communication unit.

The communication unit may be arranged to form the adjusted priority by summing the number assigned as being the priority associated with a data communication to be made by the communication unit with an adjustment value.

The communication unit may be arranged to assign a number as being a priority associated with a communication to be made by the communication unit, the assignment being performed according to a first predetermined algorithm

The communication unit may be arranged to generate the adjustment value according to a second predetermined algorithm.

The second predetermined algorithm may be capable of generating the adjustment value such that the spacing between consecutive adjustment values in the sequence of adjustment values that the second predetermined algorithm is capable of generating is smaller than the smallest spacing between two consecutive numbers in the sequence of numbers that the first predetermined algorithm is capable of generating.

The communication unit may be arranged to generate the adjustment value as a number contained within a predetermined adjustment range.

The second predetermined algorithm may be capable of generating the adjustment value such that the adjustment value is contained within the predetermined adjustment range, the predetermined adjustment range having start and end points such that the difference between those start and end points is less than the smallest spacing between two consecutive numbers in the sequence of numbers that the first predetermined algorithm is capable of generating.

The predetermined algorithm may be capable of generating the adjustment value such that the adjustment value is contained within the predetermined adjustment range, the predetermined adjustment range having start and end points such that the difference between those start and end points is greater than the smallest spacing between two consecutive numbers in the sequence of numbers that the first predetermined algorithm is capable of generating.

The communication unit may be a radio. The communication unit may be any one or more of: a Bluetooth transmitter-receiver, a WLAN transmitter-receiver, a UWB transmitter-receiver and a WiMAX transmitter-receiver.

The communication unit may be arranged to make a substantially random adjustment to the priority assigned to the data communication.

The predetermined adjustment range may have a non-uniform distribution.

The communication unit may be arranged to determine whether and/or when to communicate its data in dependence on a different priority from the adjusted priority.

According to a second embodiment of the invention, there is provided a communication device comprising a plurality of communication units for communicating data, each of the communication units being arranged to assign a priority to a data communication to be made by the communication unit, make an adjustment to the priority to form an adjusted priority, the adjustment being independent of adjustments made by others of the communication units to priorities assigned to data communications to be made by those communication units and communicate the adjusted priority to another of the plurality of communication units as being the priority associated with the data communication to be made by the communication unit.

Each of the plurality of communication units may be arranged to receive one or more priorities, each priority being associated with a data communication to be made by a respective one of the other communication units and communicate its data in dependence on the received priorities and the adjusted priority.

The communication device may be arranged such that, when two or more data communications to be made by respective ones of the communication units are associated with identical adjusted priorities, a predetermined one of said respective communication units communicates its data and the others of said respective communication units do not communicate their data.

One of the plurality of communication units may be arranged to, in respect of each data communication to be made by that communication unit, make an adjustment to the priority assigned to that data communication that includes a predetermined offset.

The plurality of communication units may be located on the same integrated circuit and/or the same circuit board.

At least one of the plurality of communication units may be capable of communicating data by means of a different communication protocol from another of the plurality of communication units.

According to a third embodiment of the invention, there is provided a method for selecting which of a plurality of communication units should be permitted to transmit data at a given time instant, the method comprising, in each of the communication units: assigning a priority to a data communication to be made by the communication unit; making an adjustment to the priority to form an adjusted priority, the adjustment being independent of an adjustment made by others of the communication units to priorities assigned to data communications to be made by those communication units; and communicating the adjusted priority to another of the plurality of communication units as being the priority associated with the data communication to be made by the communication unit.

For a better understanding of the present invention, reference is made by way of example to the following drawings, in which:

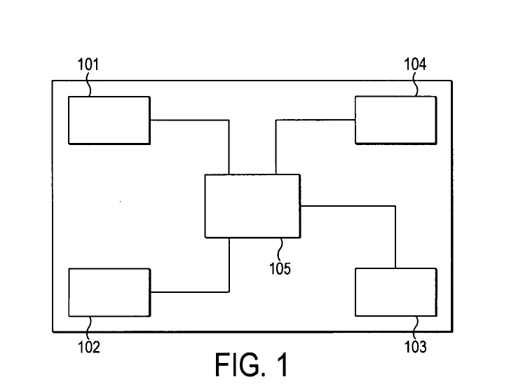

FIG. 1 shows a radio for implementing a non-deterministic distributed arbitration scheme;

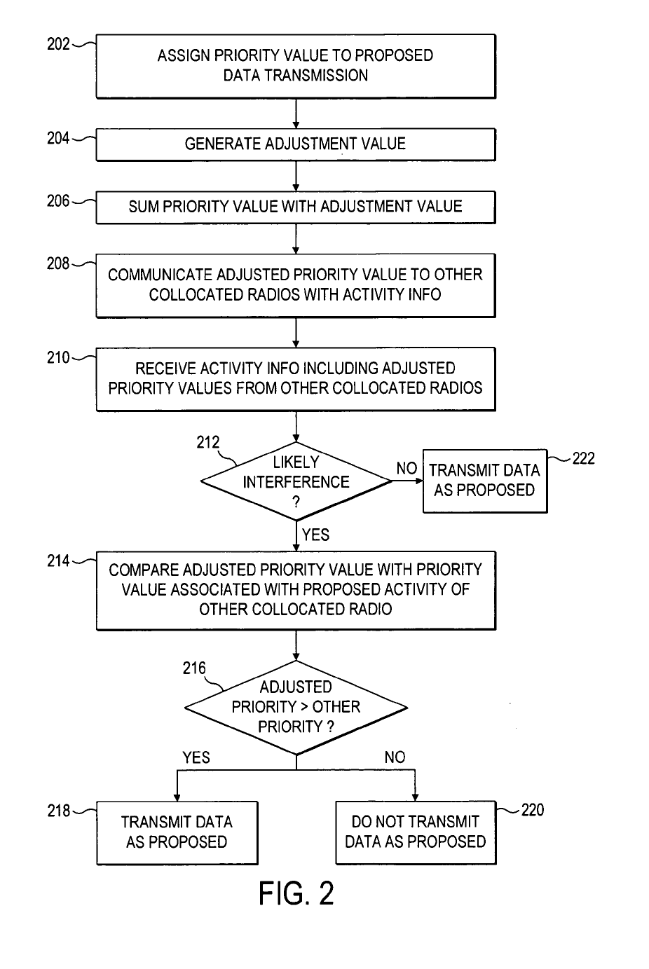

FIG. 2 shows a sequence of steps performed by a radio implementing a non-deterministic distributed arbitration scheme; and

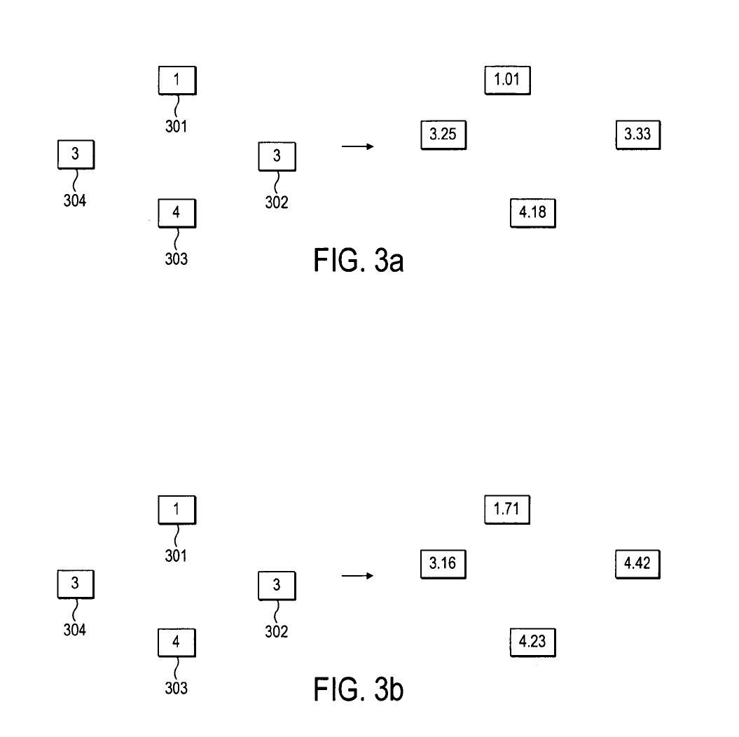

FIGS. 3a and 3b show four radios adjusting their priority values using two different adjustment ranges.

A radio may be arranged to assign a priority level to a proposed data communication and to make an adjustment to the priority level to form an adjusted priority level. The adjustment may be selected independently of adjustments selected by other communication units so that the arbitration scheme can be considered as non-deterministic. The radio may then communicate the adjusted priority level to one or more other radios. Similarly other collocated radios may form their own adjusted priority levels and communicate those adjusted values to the radio. Each of the radios may then make activity decisions based on the adjusted priority levels associated with its own proposed communication activity and those priority levels associated with the proposed activity of the other radios.

A radio that makes an independent adjustment to a priority value and communicates that adjusted value to other collocated radios makes consistent non-deterministic decisions feasible in a distributed decision-making system. This is because each individual arbiter makes activity decisions on a deterministic basis using the same data. Therefore, the arbitration decisions between the distributed arbiters are consistent even though non-determinism is introduced into the arbitration scheme by means of the independent adjustments applied by each radio to its priority values.

The priority levels assigned to data communications may be represented in different ways. For example, the priority levels may be quantised (e.g. digital numbers) or continuous (e.g. analogue voltages). The adjusted priority levels may also be either quantised or continuous, irrespective of the way in which the original priority level was represented. The priority levels may also be varied over time, either as a sequence of discrete values or as a continuously changing value.

An example of a radio capable of implementing a non-deterministic distributed arbitration scheme is shown in FIG. 1. The radio includes a transmitter 101 and a receiver 102. The transmitter and receiver may share common circuitry. The radio also includes an arbitration unit 103 for making scheduling decisions, a random number generator 104 for generating substantially random numbers used in forming the adjusted priority values and a control unit 105 for controlling operation of the radio.

The control unit may inform the arbitration unit when a communication is proposed via either the transmitter or receiver (i.e. the radio anticipates that it will be performing a transmit or receive operation in the near future). The control unit may also inform the arbitration unit of the details of the proposed activity, e.g. the activity type (transmit or receive), the frequency of operation and proposed timing of the transmission. The control unit may also assign the proposed activity a priority value, which it then adjusts to form an adjusted priority.

The control unit suitably makes the adjustment to the assigned priority value independently of similar adjustments made by others of the collocated radios. This introduces a non-deterministic element into the arbitration scheme.

The adjustment may be made by summing the priority value with a number generated by the random number generator. The number so generated is unlikely to be truly random; first because most random number generators are not capable of generating numbers on a completely random basis and second because the random number generator may generate the number from within a predetermined adjustment range. However, the number may incorporate a relatively high degree of entropy. Using a random number generator can be advantageous because it ensures that adjustment values generated by different collocated radios, using different random number generators, are independent from one another. This is one way in which the desired non-determinism can be introduced into the scheme.

The random number generator may be arranged to generate random numbers from within a predetermined adjustment range. The random number generator may be arranged to generate numbers from within the adjustment range according to a probability distribution function. The probability distribution function may be non-uniform, so that not all of the available adjustment values have an equal likelihood of being generated by the random number generator. For example, the probability distribution function may favour smaller adjustments from within the adjustment range over larger adjustments within the range.

The arbitration unit may receive activity information from other radios and use this information to decide whether or not a proposed communication should proceed or whether the proposed communication should be halted in favour of a communication to be made by another radio. This activity information may give details of communication activities being proposed by the other radios and may include parameters defining the type of activity being proposed, the frequency of operation, timing and priority. The arbitration unit may use this information to determine whether proposed communication activities may interfere with or be subject to interference from activity by other radios. The arbitration unit may make such a determination when it determines that two or more proposed communications will occur on similar frequencies at the same time. The arbitration unit may also consider the type of communication which is being proposed. For example, if two overlapping transmit operations may not be problematic but a transmit operation on a similar frequency to and overlapping in time with a receive operation may interfere with the receive operation to such an extent that the received signal cannot be correctly decoded.

If the arbitration unit determines that a proposed communication activity is likely to interfere with or be subject to interference from activity by another radio, the arbitration unit may decide whether to proceed with its own communication by comparing priority values. The arbitration unit compares the adjusted priority value associated with its own communication and the (adjusted) priority value associated with the proposed communication of the other radio and determines whether or not to proceed depending on which of the two values is higher. If the radio's own priority value is higher, then the proposed communication goes ahead. If the other radio's priority value is higher, then the radio postpones its own activity in favour of the other radio. The arbitration unit could equally decide whether or not to proceed with a communication by determining that the lower priority communication should proceed. Once the arbitration unit has decided whether or not to proceed with the communication it may communicate this decision to the transmitter or receiver as appropriate.

The arbitration unit may be implemented in hardware or software, or by a combination of the two.

In addition to receiving activity information from the other radios, a radio for implementing a distributed, non-deterministic arbitration scheme may also communicate activity information about its own proposed communication activities to other radios. As before, this information may include parameters defining the type of activity being proposed, the frequency of operation, timing and priority. The radio suitably communicates the adjusted priority level as the priority parameter. Similarly, the other collocated radios make independent adjustments to their own priority levels and communicate those adjusted priority levels as the relevant priority parameters. As a result, the arbitration decisions made by the radio are ultimately non-deterministic (since arbitration decisions are based on values that have been randomly adjusted) but also consistent, since each radio makes its arbitration decisions in a deterministic way on the same set of independently-adjusted priority values.

In some situations, it may be advantageous for one or more of the collocated radios to communicate different priority values to the other collocated radios from the priority values that it uses for its own arbitration decisions. For example, the radio might communicate adjusted priority values to the other radios while using its original priority values in its arbitration decision or the device might generate two different sets of adjusted priority values and communicate one set to the other radios while using the other set for its own arbitration decisions. Providing a different priority value to the other radios from the priority value that is used locally can be used to deliberately allow two interfering communications to happen at the same time. This can be used to force inconsistent arbitration decisions and may be beneficial for data that can tolerate some errors, e.g. Bluetooth SCO data, for which it is better to receive some data than none at all.

An example of a distributed, non-deterministic arbitration scheme is illustrated in FIG. 2. In step 202 a numeric priority value is assigned to a proposed data transmission. In step 204 a random number is generated, which is summed with the priority value in step 206. In step 208 the adjusted priority value is communicated to other collocated radios together with other activity information. In step 210 activity information including adjusted priority values is received from other collocated radios. In step 212, the received activity information is used to determine whether the proposed transmission is likely to interfere with the activity of the other collocated radios. If no, the proposed transmission proceeds as planned (step 222). If yes, the adjusted priority value associated with the proposed transmission is compared with the adjusted priority values received from the other radios (step 214). It is then determined whether the adjusted priority value associated with the radio's proposed transmission is greater than the priority values associated with the proposed communication activities of the other radios (step 216). If so, the radio continues to transmit its data as proposed (step 218). If not, the radio does not transmit its data (step 220).

If the radio decides not to proceed with its proposed communication, the radio may abandon that communication altogether or may reschedule it for a different time and/or frequency than originally planned. The radio may allocate a different priority to a rescheduled communication than it allocated to the communication originally. For example, the communication may be deemed more important when it has had to be delayed and may be allocated a higher priority in consequence.

The radio may use adjustments of different sizes to achieve different objectives. For example, relatively small adjustments may be made to the priority value if the aim of the adjustment is merely to provide a means of distinguishing between identical priorities. Alternatively, relatively large adjustments may be made if the aim of the adjustment is to provide the possibility of activities associated with relatively low priorities to be scheduled before activities associated with higher priorities.

The adjustments applied to the priority values may be selected in a substantially random manner, independently of any other objectives. The different aims described above may therefore be achieved by randomly selecting an adjustment value from within a predetermined adjustment range. The adjustment range may be such that an adjustment value selected randomly from within this range could enable a relatively low-priority communication to overtake other, previously higher-priority communications. Alternatively, the adjustment range may be such that an adjustment value selected randomly from within the adjustment range can only distinguish between like priorities. This may be achieved by requiring the random number generator to select a number randomly from within a predetermined adjustment range, with the start and end points of the range being selected to achieve the desired effect. Alternatively, the adjustment value may be formed by always generating a random number from within the same range and then applying an appropriate adjustment function to the generated number (e.g. by moving a decimal point) to give adjustment values within the desired range.

The adjustment value may be selected from within the adjustment range according to either a uniform or a non-uniform probability distribution function.

FIGS. 3a and 3b each show an example of a predetermined adjustment range from within which suitable adjustment values are randomly selected. In FIG. 3a, four communication devices 301 to 304 are illustrated. Each of the communication devices is proposing a communication activity that is associated with a respective priority value. In FIG. 3a, device 301 is proposing a communication having priority ‘one’, device 302 is proposing a communication having priority ‘three’, device 303 is proposing an activity having priority ‘four’ and device 304 is proposing a communication having priority ‘three’. Each of the four devices then applies a random adjustment to the priority value associated with its proposed communication activity, as shown on the right-hand side of the figure. In FIG. 3a, the predetermined adjustment range is 0 to 0.50. In the example shown in FIG. 3a, by randomly adjusting the priority values within the range 0 to 0.50, the previously identical priorities associated with devices 302 and 304 have been distinguished from each other so that, if these proposed communication activities were found likely to interfere, both devices are able to determine unambiguously that the communication activity proposed by device 302 should take precedence over the activity proposed by device 304. However, the adjustment range in this example is sufficiently limited in scope that none of the proposed activities has been able to “overtake” an activity of higher priority by means of the random adjustment.

FIG. 3b illustrates a similar scenario, but in this example the adjustment range is 0 to 1.50. In this example, the larger adjustment range has not only enabled the priorities of devices 302 and 304 to be distinguished from each other but has also enabled the communication activity proposed by device 302 to become a higher priority activity than that proposed by device 304, which was previously considered to be of higher priority.

The communication unit may be considered as assigning a priority number to a data communication to be made by the communication unit according to a first predetermined algorithm. The communication unit can also be considered as generating an adjustment value for summing with the priority number using a second predetermined algorithm.

If the adjustment value is to enable the communication unit to distinguish between like priorities, the second predetermined algorithm should suitably generate the adjustment value such that the spacing between consecutive adjustment values is smaller than a spacing between consecutive priority numbers. So, for example, if the available sequence of priority numbers is 0, 1, 2, 3 . . . etc, the spacing between two consecutive adjustment values should suitably be less than one, e.g. 0.25, 0.50, 0.75 . . . etc.

A mechanism may be required to resolve the situation in which two or more data communications are associated with the same adjusted priorities. One possible approach is for the individual radios to be arranged to always select the same radio to communicate when two or more of the radios have data to be communicated that is associated with the same adjusted priority value. Another option is to ensure that the adjustment process can never result in two or more radios generating the same adjusted priority value. For example, one of the devices may be arranged to apply an additional offset to each adjusted priority value that it generates. Suitably this offset is predetermined and smaller than the smallest spacing between two adjacent adjustment values that might be used by any of the collocated radios.

If the adjustment value is intended to allow a finite probability of a lower priority communication being able to overtake higher priority communication in the queue, the second predetermined algorithm should suitably be capable of generating the adjustment value from within an adjustment range that spans a greater range that the spacing between consecutive priority numbers. An example of this is shown in FIG. 3b in which the difference between that start and end points of the adjustment range is 1.5 and the spacing between consecutive priority numbers is one. Similarly, if the adjustment value is not intended to allow a finite probability of a lower priority communication being able to overtake higher priority communication in the queue, the second predetermined algorithm should suitably be capable of generating the adjustment value from within an adjustment range that spans less than the spacing between consecutive priority numbers. An example of this is shown in FIG. 3a, in which the spacing between priority numbers is one and the difference between the start and end points of the adjustment range is 0.5.

Different adjustment ranges may therefore be employed by a radio to vary the determinism of priority comparisons. A minimal potential variation of the priority value will tend to only provide a distinction between like priorities. This has the advantage of allowing two radios to determine independently and consistently which radio's communication should go ahead when their priority levels are identical. It also has the advantage of avoiding a scenario in which either there is a stalemate situation in which neither radio proceeds with its communication or the opposite situation occurs and both radios proceed with their communication as planned and at least one of those communications is subject to damaging interference. A larger potential variation to the priority values allows lower priority activities to surpass higher priority activities with some probability. This is potentially advantageous in systems where lower priority activities are seldom scheduled due to higher priority activities often being proposed at the same time.

The adjustment range could include negative numbers, such that summing the priority value with the adjustment value causes the priority value to decrease.

Each radio within a device may use the same adjustment range (as shown in FIGS. 3a and 3b) or may use different adjustment ranges. If the radios use the same adjustment range they may communicate with each other to negotiate which adjustment range to use. Alternatively, each radio may individually determine what range to use on the basis of its own objectives.

The arbitration method described above may be implemented by radios located in the same device or in different devices. However, the arbitration method may be particularly beneficial when implemented by radios that are located in the same device, particularly if the radios are located on the same integrated circuit. The collocated radios may be arranged to operate over different communication networks and/or different communication protocols. For example, a device may contain both a Bluetooth radio and a WLAN radio. The radio might also be a UWB or WiMAX device.

Although the distributed, non-deterministic arbitration method presented herein has been described with reference to radios and wireless communications, it should be understood that this method is generally applicable to any type communication units, e.g. functional components of a computer wanting to arbitrate access to a bus.

The applicant hereby discloses in isolation each individual feature described herein and any combination of two or more such features, to the extent that such features or combinations are capable of being carried out based on the present specification as a whole in light of the common general knowledge of a person skilled in the art, irrespective of whether such features or combinations of features solve any problems disclosed herein, and without limitation to the scope of the claims. The applicant indicates that aspects of the present invention may consist of any such feature or combination of features. In view of the foregoing description it will be evident to a person skilled in the art that various modifications may be made within the scope of the invention.

1. A communication unit for communicating data in dependence on a priority associated with a data communication to be made by that communication unit and on a priority associated with a data communication to be made by another communication unit, the communication unit being arranged to:
assign a priority to a data communication to be made by the communication unit;
make an adjustment to the priority to form an adjusted priority, the adjustment being independent of an adjustment made by the other communication unit to a priority assigned to a data communication to be made by that communication unit; and
communicate the adjusted priority to the other communication unit as being the priority associated with the data communication to be made by the communication unit.

2. A communication unit as claimed in claim 1, wherein the communication unit is arranged to determine whether and/or when to communicate its data in dependence on the adjusted priority.

3. A communication unit as claimed in claim 1, wherein the communication unit is arranged to receive a priority associated with a data communication to be made by the other communication unit from the other unit.

4. A communication unit as claimed in claim 3, wherein the communication unit is arranged to communicate its data in dependence on the priority received from the other unit.

5. A communication unit as claimed in claim 1, wherein the communication unit is arranged to receive from the other communication unit data defining communication resources that the other unit requires to make a data communication, the communication unit being arranged to determine from that data if the data communication to be made by the communication unit and the data communication to be made by the other unit would interfere.

6. A communication unit as claimed in claim 5, wherein the communication unit is arranged to, if it determines that the data communication to be made by the communication unit and the data communication to be made by the other unit would interfere, communicate its data in dependence on the adjusted priority and the priority associated with the data communication to be made by the other unit.

7. A communication unit as claimed in claim 6, wherein the communication unit is arranged to, if the adjusted priority is higher than the priority associated with the data communication to be made by the other unit, communicate its data.

8. A communication unit as claimed in claim 6, wherein the communication unit is arranged to, if the adjusted priority is lower than the priority associated with the data communication to be made by the other unit, not communicate its data.

9. A communication unit as claimed in claim 3, wherein the communication unit is arranged to receive an adjusted priority associated with a data communication to be made by the other communication unit from the other unit and to treat the adjusted priority as being the priority associated with that data communication.

10. A communication unit as claimed in claim 1, wherein the communication unit is arranged to assign a number as being the priority associated with a data communication to be made by the communication unit.

11. A communication unit as claimed in claim 10, wherein the communication unit is arranged to form the adjusted priority by summing the number assigned as being the priority associated with a data communication to be made by the communication unit with an adjustment value.

12. A communication unit as claimed in claim 1, wherein the communication unit is arranged to assign a number as being a priority associated with a communication to be made by the communication unit, the assignment being performed according to a first predetermined algorithm

13. A communication unit as claimed in claim 1, wherein the communication unit is arranged to generate the adjustment value according to a second predetermined algorithm.

14. A communication unit as claimed in claim 13, wherein the second predetermined algorithm is capable of generating the adjustment value such that the spacing between consecutive adjustment values in the sequence of adjustment values that the second predetermined algorithm is capable of generating is smaller than the smallest spacing between two consecutive numbers in the sequence of numbers that the first predetermined algorithm is capable of generating.

15. A communication unit as claimed in claim 10, wherein the communication unit is arranged to generate the adjustment value as a number contained within a predetermined adjustment range.

16. A communication unit as claimed in claim 15, wherein the second predetermined algorithm is capable of generating the adjustment value such that the adjustment value is contained within the predetermined adjustment range, the predetermined adjustment range having start and end points such that the difference between those start and end points is less than the smallest spacing between two consecutive numbers in the sequence of numbers that the first predetermined algorithm is capable of generating.

17. A communication unit as claimed in claim 15, wherein the predetermined algorithm is capable of generating the adjustment value such that the adjustment value is contained within the predetermined adjustment range, the predetermined adjustment range having start and end points such that the difference between those start and end points is greater than the smallest spacing between two consecutive numbers in the sequence of numbers that the first predetermined algorithm is capable of generating.

18. A communication unit as claimed in claim 1, wherein the communication unit is a radio.

19. A communication unit as claimed in claim 1, wherein the communication unit is a Bluetooth transmitter-receiver.

20. A communication unit as claimed in claim 1, wherein the communication unit is a WLAN transmitter-receiver.

21. A communication unit as claimed in claim 1, wherein the communication unit is a UWB transmitter-receiver.

22. A communication unit as claimed in claim 1, wherein the communication unit is a WiMAX transmitter-receiver.

23. A communication unit as claimed in claim 1, wherein the communication unit is arranged to make a substantially random adjustment to the priority assigned to the data communication.

24. A communication unit as claimed in claim 15, wherein the predetermined adjustment range has a non-uniform distribution.

25. A communication unit as claimed in claim 1, wherein the communication unit is arranged to determine whether and/or when to communicate its data in dependence on a different priority from the adjusted priority.

26. A communication device comprising a plurality of communication units for communicating data, each of the communication units being arranged to:
assign a priority to a data communication to be made by the communication unit;
make an adjustment to the priority to form an adjusted priority, the adjustment being independent of adjustments made by others of the communication units to priorities assigned to data communications to be made by those communication units; and
communicate the adjusted priority to another of the plurality of communication units as being the priority associated with the data communication to be made by the communication unit.

27. A communication device as claimed in claim 26, wherein each of the plurality of communication units is arranged to:
receive one or more priorities, each priority being associated with a data communication to be made by a respective one of the other communication units; and
communicate its data in dependence on the received priorities and the adjusted priority.

28. A communication device as claimed in claim 26, wherein the communication device is arranged such that, when two or more data communications to be made by respective ones of the communication units are associated with identical adjusted priorities, a predetermined one of said respective communication units communicates its data and the others of said respective communication units do not communicate their data.

29. A communication device as claimed in claim 26, wherein one of the plurality of communication units is arranged to, in respect of each data communication to be made by that communication unit, make an adjustment to the priority assigned to that data communication that includes a predetermined offset.

30. A communication device as claimed in claim 26, wherein the plurality of communication units are located on the same integrated circuit.

31. A communication device as claimed in claim 26, wherein the plurality of communication units are located on the same circuit board.

32. A communication device as claimed in claim 26, wherein at least one of the plurality of communication units is capable of communicating data by means of a different communication protocol from another of the plurality of communication units.

33. A method for selecting which of a plurality of communication units should be permitted to transmit data at a given time instant, the method comprising, in each of the communication units:
assigning a priority to a data communication to be made by the communication unit;
making an adjustment to the priority to form an adjusted priority, the adjustment being independent of an adjustment made by others of the communication units to priorities assigned to data communications to be made by those communication units; and
communicating the adjusted priority to another of the plurality of communication units as being the priority associated with the data communication to be made by the communication unit.

34. (canceled)

35. (canceled)

36. (canceled)
